(19) United States
(12) Patent Application Publication
(10) Pub. No.: US 2020/0300259 A1
(43) Pub. Date: Sep. 24, 2020

(54) FLOATING PUMP

(71) Applicant: HYTRANS BEHEER B.V., Lemmer (NL)

(72) Inventor: Robert Dirk HUT, Wergea (NL)

(73) Assignee: HYTRANS BEHEER B.V., Lemmer (NL)

(21) Appl. No.: 16/760,959

(22) PCT Filed: Oct. 31, 2018
(86) PCT No.: PCT/NL2018/050727

§ 371 Date: May 1, 2020

(30) Foreign Application Priority Data
Nov. 3, 2017 (NL) 2019849

(51) Int. Cl. F04D 29/02; F04D 13/06

(52) U.S. Cl. CPC F04D 29/026; F04D 13/066; F05D 2300/43; F05D 2260/95; F05D 2300/603; F05D 2300/612

(57) ABSTRACT

A floating pump for pumping a liquid includes a pump housing; and a pump element arranged in or on the housing and provided with a fan, and operatively connected to a drive. The pump housing is configured to keep the floating pump substantially wholly floating.

The present invention relates to a floating pump for pumping a liquid, such as water, in the case of flooding. Such a floating pump can also be utilized in other applications, for instance for the purpose of pumping a tank empty. A floating pump is understood to mean a pump embodied such that it is able to remain floating in the liquid for pumping.

Floating pumps known in practice are provided with one or more floating bodies which ensure that the pump actually remains floating in the liquid. One of the drawbacks of such conventional pumps is that they are relatively voluminous, i.e. require a relatively large volume in order to allow the pump to float. This limits inter alia the handling and utility of such pumps. This is particularly relevant if limited space is available and/or if time pressure is relatively high, for instance in the case of flooding.

The present invention has for its object to provide a floating pump whereby the above stated drawbacks are obviated or at least reduced, and to thereby provide a pump which can be utilized effectively.

This object is achieved with floating pump for pumping a liquid according to the invention, wherein the floating pump comprises:
a pump housing;
a pump element arranged in or on the housing and provided with a fan, and operatively connected to a drive,
wherein the pump housing is configured to keep the floating pump substantially wholly floating.

The floating pump according to the invention is suitable for pumping a liquid, wherein the liquid can for instance be water in the case of a flood or a flooded space and the like. The pump is provided for this purpose with a pump housing in which or on which a pump element is arranged. The pump element according to the invention is provided with a fan which is rotated during use by means of a drive operatively connect thereto in order to enable pumping of the water.

The floating pump according to the present invention is provided with a pump housing configured to keep the floating pump substantially wholly floating. This means that the pump housing itself functions as floating element. This has the advantage that separate floating bodies which have to be secured to or on the pump (housing) can be wholly or at least partially dispensed with.

By providing the pump housing according to the invention such that it functions as floating element, the overall volume of the floating pump can thereby remain limited. An additional advantage is that all or at least some of the conventional floating bodies can thereby be dispensed with, and no additional weight, which must then in turn also be kept afloat, need be added. The overall weight of the floating pump is hereby reduced. This makes the floating pump according to the invention easier to handle. This makes the utility more flexible and also simpler. This latter is particularly relevant in the case of an emergency situation, such as in the case of flooding, wherein rapid action is required.

The pump housing is preferably provided from a plastic material. In the currently preferred embodiment the pump housing comprises a foam-like material wherein fibres, for instance glass fibres and/or carbon fibres, are provided. Use of the foam-like material enables the eventually obtained density of the floating pump to be adapted to the desired specifications. Use is preferably made here of a type of sandwich structure for the pump housing.

The use of a fibre-reinforced plastic, preferably in a sandwich structure, has the additional advantage that a rigid housing is obtained. Twisting of the pump housing is hereby counteracted. Such a twisting of the pump housing can in practice occur in the case of relatively great forces which occur. In conventional pumps this is intensified further in that the pump element is usually bearing-mounted on one side, whereby the twisting is even more likely to occur. By giving the pump housing a sufficiently rigid form the risk of twisting is reduced with the floating pump according to the invention.

The pump system according to the invention makes it possible to provide additional buoyancy and, in addition, to create additional rigidity. This is preferably provided in integrated manner so as to thereby obtain an effective pump system which can be utilized in a wide field of application.

A significant weight reduction becomes achievable with the floating pump according to the invention. In conventional pumps the pump housing, the floater, the frame and the handgrips together form 60-67% of the overall weight of the pump assembly. Application of the invention lowers the percentage of these components to 32-49% of the overall weight in the pump assembly. The overall weight of the new pump can here drop to for instance 50-75% of the weight of a conventional pump.

Maintaining the same pump capacity of about 20 m³/min. the floating pump according to the invention can be embodied with a weight which, as already stated above, is considerably lower than similar conventional pumps. This considerably improves the handling of the floating pump. Floating pumps according to the invention are for instance provided with a capacity in the range of 1,500-20,000 l/m. It will be apparent that other embodiments according to the invention are likewise possible.

In an advantageous embodiment according to the invention the pump housing is provided with one or more forms generating upward force during use.

By providing one or more traditional forms of the pump housing on the pump housing the buoyant force can be increased and/or be adapted to the desired specifications. It is for instance possible here to envisage additional edges, bulges, protrusions and other volume elements whereby the pump housing can commonly be provided with a greater volume in a manner such that the buoyant force is increased. The form can here be adapted to the conditions in which the pump according to the invention is utilized and/or to specifications of the pump itself, including dimensions, weight and capacity.

Using an adjusted design enables this form of the floating pump according to the invention to be adapted in effective manner to the desired specifications. This greatly increases the flexibility of the pump system according to the invention.

The pump housing preferably comprises an upper housing part and a lower housing part. Providing the housing from two main components makes production relatively simple and enables relatively simple maintenance to be performed in use.

In an advantageous embodiment according to the invention the upper housing part is provided with a first pump housing part and a second floater part.

Providing the upper housing part from a plurality of parts, particularly a first pump housing part and a second floater part, makes it possible in effective manner to obtain additional buoyancy on the one hand and to obtain sufficient rigidity on the other. In a currently preferred embodiment the second floater part is manufactured by rotation moulding. The relevant component can hereby be manufactured in effective manner. The first pump housing part and the second floater part can if desired be provided from a foam-like material, or conversely not be provided therefrom. This is preferably adapted to the intended application of the relevant pump system according to the invention.

The second floater part can preferably be connected removably to the other part or parts of the pump housing. A modular system is hereby obtained. It is for instance additionally possible hereby to adapt the floater part to the specific application. This further increases the flexible application options of the pump system according to the invention. It is thus for instance possible to apply a removable floater which, if desired, can be removed from the pump system in the case of for instance application in a cellar.

In a number of the possible embodiments according to the invention the pump system is further provided with a removable suction flange. This further increases the flexible application options already stated above. Such a removable suction flange is for instance advantageously applied in relatively small pumps. Removing the suction flange enables and/or simplifies mounting of a fan.

In a further embodiment according to the present invention the pump housing is configured to mount thereon or fasten thereto displacing elements, preferably comprising a slide plate, wheels or carrying loops.

By mounting or fastening displacing elements on or to the pump housing the floating pump can be efficiently displaced in effective manner. Depending on the choice of the type of displacing element and pump dimensions, it is even possible to manually displace the floating pump. This also depends on the specific embodiment of the pump according to the invention. This effect is intensified further by the weight reduction which can be realized with the pump according to the present invention compared to similar conventional pumps.

The displacing elements are preferably secured on the pump housing close to a fastening of individual housing parts, i.e. close to the fastening of the upper housing part and the lower housing part. On the one hand, this has a stabilizing effect on the floating pump when this is present in a liquid, and on the other hand this makes it possible also to use a fastening between the upper and the lower housing part for fastening the displacing elements thereto. It is hereby possible to dispense with separate connecting elements for the displacing elements, so that the overall weight of the floating pump can remain limited and can even be further reduced compared to conventional pumps. It will be apparent that the flexibility, ease of handling and utility of the floating pump according to the invention are hereby further increased.

In an advantageous embodiment according to the invention the pump housing is provided with a bumper arranged substantially all the way around.

Providing a bumper arranged substantially all the way around prevents damage to the pump, for instance to the pump housing. This is particularly relevant if the floating pump according to the invention is utilized in emergency situations wherein the pump housing has to take a sufficiently robust form.

The fan of the floating pump can be provided from a metal as well as from a plastic material. The metal is for instance aluminium. The plastic material can consist of diverse components, for instance the plastic material of the pump housing, a material reinforced with glass fibre and/or carbon fibre and/or aramid fibre, for instance a thermoplastic material. Combinations of the materials are also possible. The application of plastic material has the advantage that corrosion is prevented and weight can optionally be limited further.

The invention also relates to a pump system comprising a floating pump in an embodiment according to the invention.

Such a pump system provides the same effects and advantages as for the floating pump.

The invention further also relates to a method for pumping a liquid, the method comprising the steps of:
providing a floating pump in a pump system in an embodiment according to the invention;
connecting the pump system; and
pumping a liquid.

Such a method provides the same effects and advantages as stated for the floating pump and/or the pump system.

The method can be applied in a normal situation in which a liquid for instance has to be transfer-pumped continuously or periodically from a tank or other container, and in an emergency situation in the case of a flood and/or flooding of a cellar. It is particularly application of the floating pump in an embodiment according to the invention with a great robustness, stable positioning in the liquid and reduced weight which enables flexible and efficient application of the method according to the invention.

Further advantages, features and details of the invention are elucidated on the basis of preferred embodiments thereof, wherein reference is made to the accompanying drawings, in which:

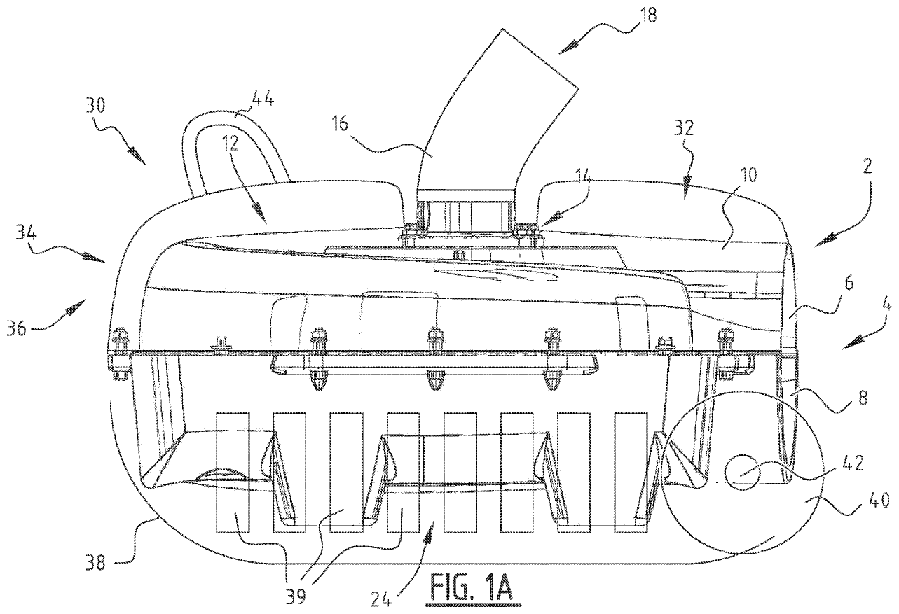

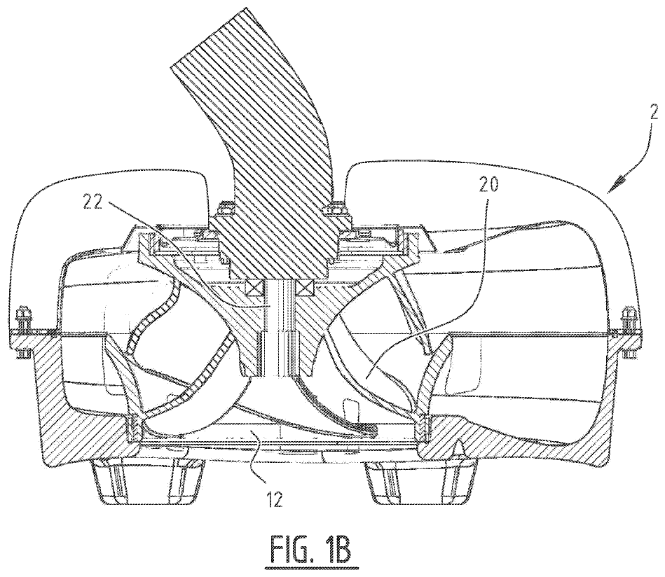

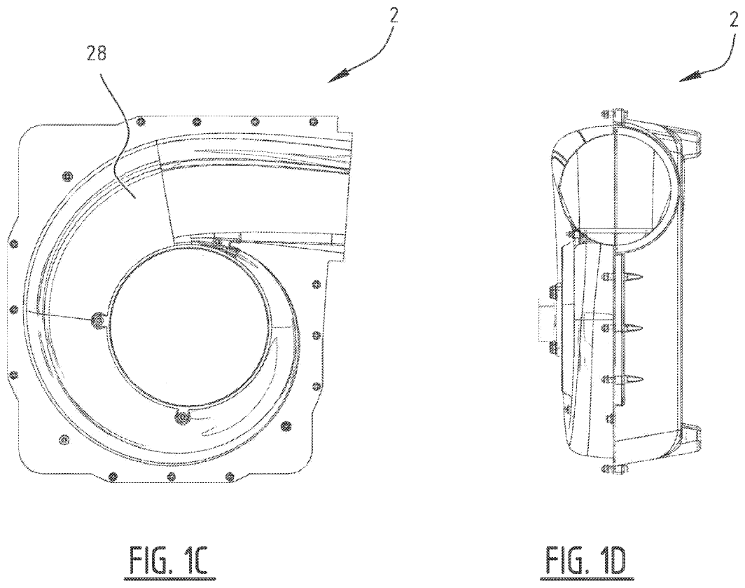

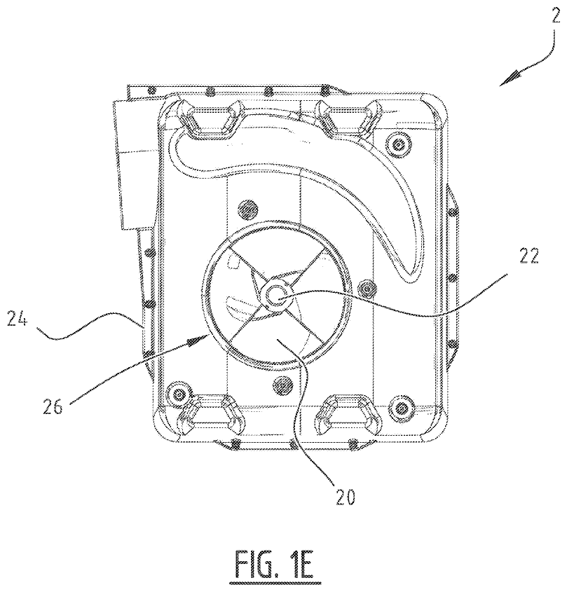

FIGS. 1A-E are views of a floating pump according to the invention;

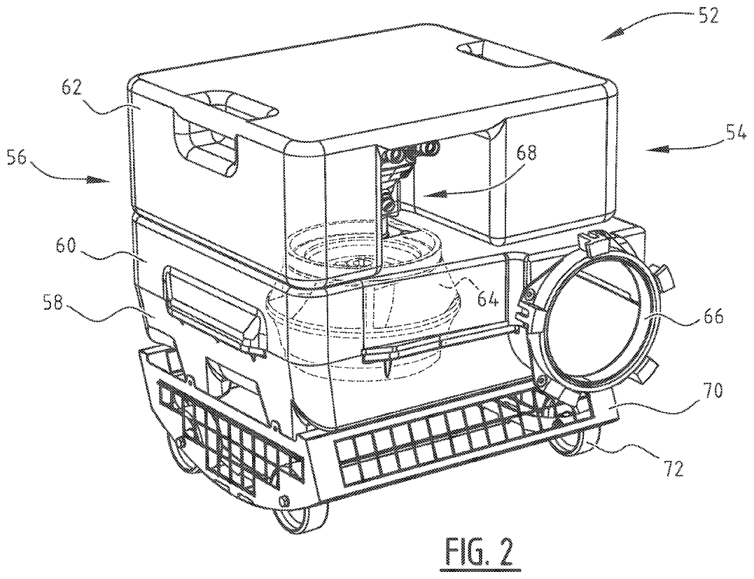

FIG. 2 are views of an alternative floating pump according to the invention; and

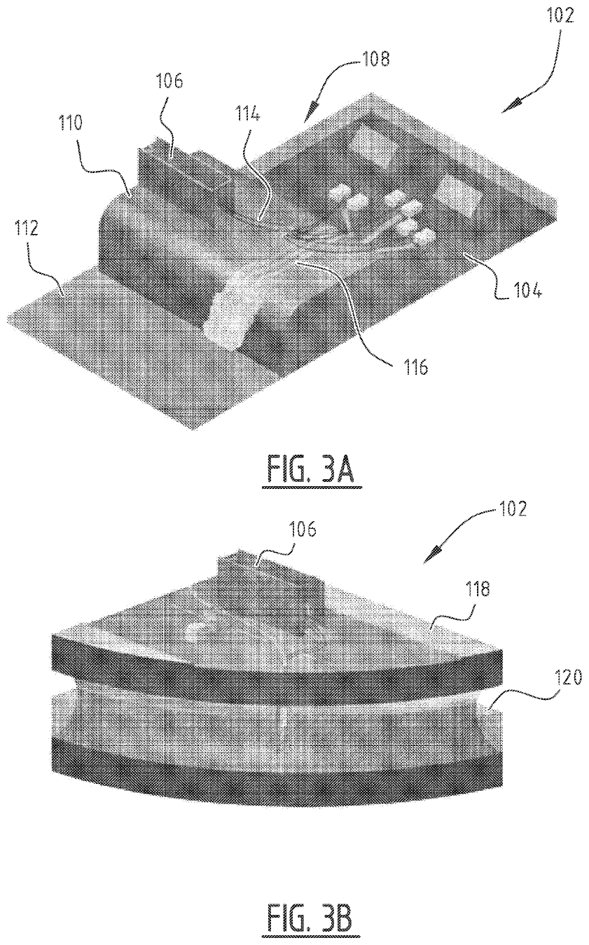

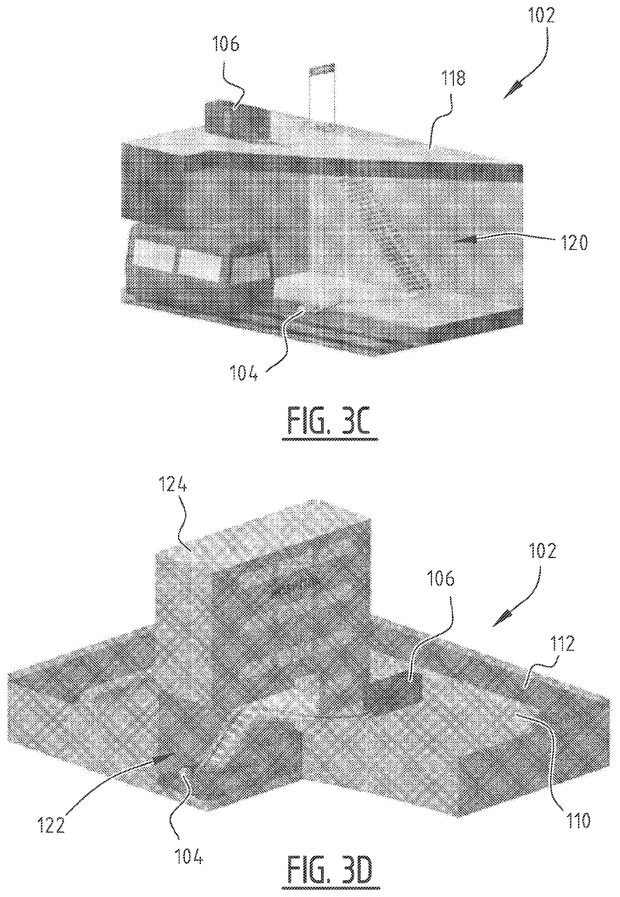

FIGS. 3A-D are schematic views of applications of the floating pump of FIG. 1.

Floating pump 2 (FIGS. 1A-E) is provided with housing 4 comprising upper housing part 6 and lower housing part 8. In the shown embodiment upper housing part 6 is connected to lower housing part 8 using fastening elements 10, embodied in the shown embodiment as bolts. Pump element 12 is bearing-mounted on one side on first bearing 14 and second bearing 16. Connection 18 is further provided for the purpose of connecting floating pump 2 to other parts of a pump system. Provided in the shown embodiment is fan element 20 which is arranged on shaft 22 and with which a liquid can be transported via connection 18. Liquid is for this purpose sucked up from underside 24 via opening 26 arranged therein using the fan 20 arranged on shaft 22. In the shown embodiment the sucked-up liquid is transported via a type of spiral casing configuration 28 to connection 18 and then transferred to another location.

The housing of the shown floating pump 2 is manufactured from a plastic material comprising carbon, glass and/or aramid fibres. A stable and robust pump housing 4 is obtained using a sandwich structure wherein use is made of a foam material, in which the fibres are preferably arranged.

In the shown embodiment floating pump 2 is able to displace about 20,000 litres per minute. The overall weight of pump 2 is about 50-75% of the weight of a conventional pump, wherein the weight of pump 2 according to the invention is formed for the most part by the weight of pump element 12 and fan 20, wherein housing 4 has a very limited weight. It has been found that for preferred pumps 2 the pump element including fan makes up a total of between 50% to 80% of the overall weight relative to housing 4 with inter alia bearings 14, 16 and connection 18.

In the shown embodiment additional forms 30 are optionally arranged for the purpose of controlling the buoyant force. Form 30 is arranged on the upper side 32 of upper housing part 6. It is also possible to arrange an additional form element 34 on side 36 of pump 2. This is preferably arranged on upper part 6 of housing 4 in order to thereby provide a greater stability of pump 2 in a liquid. It is hereby possible to realize a self-righting configuration of pump 2. It is hereby achieved that pump 2 can also right itself if pump 2 is pulled askew by or via connection 18, or comes to lie askew or is even turned upside down by other loads. It will be apparent that a large number of forms 30, 34, which can be applied separately or in combination with each other, are possible in similar manner.

Slide plate 38, which is shown schematically in FIG. 1A, is further optionally provided. In this schematically shown embodiment slide plate 38 is mounted on housing 4 via fastening elements 10. Also provided are a number of protective profiles 39 which have inter alia the filtering function of preventing for instance waste from being able to find its way into pump 2. One or more wheels 40 can additionally or alternatively be arranged, which are in the shown schematic embodiment preferably likewise secured via wheel shaft 42 to fastening elements 10 and housing 4 of pump 2. If desired, one or more hoisting loops 44 can be provided with which it is possible to displace pump 2 in effective manner. In the shown schematic embodiment hoisting loops or handles 44 are likewise arranged on fastening elements 10. These are shown schematically in the figure. It will be apparent that other embodiments for the schematically shown displacing elements of slide plate 38, wheel 40, hoisting loops/handle 44 are possible for the skilled person, as is application of other fastening elements and fastening points.

In an alternative embodiment pump 52 (FIG. 2) is provided with housing 54 with upper housing part 56 and lower housing part 58. Upper housing part 56 is provided from first pump housing part 60 and second floater part 62. Pump/fan 64 is arranged in housing 54. Housing 54 is further provided with suction flange 66. In the shown embodiment first pump housing part 60 is provided with connections 68.

In the shown embodiment lower housing part 58 and floater part 62 are manufactured from a plastic material having a sandwich structure, preferably provided with carbon, glass and/or aramid fibres. Pump housing 54 can be placed on cart/carrier 70 provided with wheels 72. It is hereby possible for one person to move pump 52 in simple manner.

It is noted that it will be apparent to the skilled person that components and features of pumps 2, 52 can be interchanged. It is thus for instance possible to provide upper housing part 6 of pump 2 from two (or more) parts.

Pump systems 102 (FIGS. 3A-D) can for instance be applied in the case of flooding occurring in an area (FIG. 3A). One or more pumps 104 can here be driven from drive 106. Water is discharged from a flooded area 108, over dike 110 and to discharge area or regular water reserve 112. Drive 106 is here connected via drive line 114 to individual pumps 104. The drive for instance takes a hydraulic form. It will be apparent that other embodiments are also possible. Pumps 104 here float in water in area 108. Sucked-up water is discharged via discharge conduits 116 from pumps 104 to destination area 112, which functions as discharge area or regular water reserve.

If desired, it is also possible to place drive 106 on a ground surface 118 where an underground channel 120 is pumped empty (FIG. 3B).

Pump system 102 can also be applied in similar manner for the purpose of pumping empty a flooded train or metro tunnel 120 (FIG. 3C).

A cellar 122 of for instance a hospital 124 can further be pumped empty in similar manner using a pump system 102 (FIG. 3D). In the shown embodiment water is discharged via pump system 102 from cellar space 122, over dike 110 and to destination area 112.

In a situation in which transfer pumping is required, pump system 102 is carried or moved to the desired location. A drive 106 can here be operatively connected to one or more pumps 2. After installation, the water or other liquid can be transferred by pumping.

It will be apparent that the shown embodiments are examples of possible applications of pump 2 and pump system 102. Other embodiments and applications are likewise possible.

The present invention is by no means limited to the above described preferred embodiments thereof. The rights sought are defined by the following claims, within the scope of which many modifications can be envisaged.

1. A floating pump for pumping a liquid, comprising:
a pump housing; and
a pump element arranged in or on the housing and provided with a fan, and operatively connected to a drive,
wherein the pump housing is configured to keep the floating pump substantially wholly floating.

2. The floating pump as claimed in claim 1, wherein the pump housing is provided with one or more forms generating upward force during use.

3. The floating pump as claimed in claim 1, wherein the pump housing comprises an upper housing part and a lower housing part.

4. The floating pump as claimed in claim 1, wherein the upper housing part is provided with a first pump housing part and a second floater part.

5. The floating pump as claimed in claim 4, wherein the second floater part is removably connectable to the other part or parts of the pump housing.

6. The floating pump as claimed in claim 1, wherein at least a part of the pump housing is provided with a sandwich structure configured to provide rigidity to the pump housing.

7. The floating pump as claimed in claim 6, wherein the sandwich structure comprises a foam material and further a fibre material.

8. The floating pump as claimed in claim 7, wherein the fibre material comprises at least one of glass fibres and carbon fibres.

9. The floating pump as claimed in claim 1, further comprising a removable suction flange.

10. The floating pump as claimed in claim 1, wherein the pump housing is configured to mount thereon or fasten thereto displacing elements comprising one or more of a slide plate, wheels or carrying loops.

11. The floating pump as claimed in claim 10, wherein the displacing elements are secured on the pump housing close to a fastening between individual housing parts.

12. The floating pump as claimed in claim 1, wherein the pump housing is provided with a bumper arranged substantially all the way around the pump housing.

13. The floating pump as claimed in claim 1, wherein the fan is provided substantially from a plastic material.

14. A pump system comprising a floating pump for pumping a liquid, the the pump comprising:
a pump housing; and
a pump element arranged in or on the housing and provided with a fan, and operatively connected to a drive,
wherein the pump housing is configured to keep the floating pump substantially wholly floating.

15. A method for pumping a liquid, comprising:
providing a floating pump in a pump system for pumping a liquid, the pump comprising:
a pump housing; and
a pump element arranged in or on the housing and provided with a fan, and operatively connected to a drive,
wherein the pump housing is configured to keep the floating pump substantially wholly floating:
connecting the pump system; and
pumping the liquid.

16. The floating pump as claimed in claim 2, wherein the pump housing comprises an upper housing part and a lower housing part.

17. The floating pump as claimed in claim 16, wherein the upper housing part is provided with a first pump housing part and a second floater part, wherein the second floater part is removably connectable to the other part or parts of the pump housing.

18. The floating pump as claimed in claim 17, wherein at least a part of the pump housing is provided with a sandwich structure configured to provide rigidity to the pump housing, and wherein the sandwich structure comprises a foam material and further a fibre material.

19. The floating pump as claimed in claim 17, wherein the pump housing is configured to mount thereon or fasten thereto displacing elements comprising one or more of a slide plate, wheels or carrying loops.

20. The floating pump as claimed in claim 19, wherein the pump housing is provided with a bumper arranged substantially all the way around the pump housing.
